(19) United States
(12) Patent Application Publication
(10) Pub. No.: US 2026/0053708 A1
(43) Pub. Date: Feb. 26, 2026

(54) PILL-CUTTER-AND-GRINDER

(71) Applicant: E-LINK PLASTIC & METAL INDUSTRIAL CO., LTD., NEW TAIPEI CITY (TW)

(72) Inventor: WEN-HAI TANG, NEW TAIPEI CITY (TW)

(21) Appl. No.: 18/813,507

(22) Filed: Aug. 23, 2024

(51) Int. Cl. A61J 7/00

(52) U.S. Cl. CPC A61J 7/0007

(57) ABSTRACT

A pill-cutter-and-grinder has a main body, a cutting lid, and a grinding container. The main body has a cutting seat and a grinding head. The cutting seat and the grinding head are mounted on two ends of the main body respectively. The cutting lid is mounted on the main body close to the cutting seat. The cutting lid has a blade. A cutting edge of the blade faces toward the cutting seat. The grinding container can be combined with the main body, such that the grinding head can be located in the grinding container and contacts a bottom of the grinding container. By closing the cutting lid to drive the blade, a pill placed on the cutting seat can be cut. In addition, through the combination of the grinding container and the main body, a pill placed in the grinding container can be ground.

### BACKGROUND OF THE INVENTION

### 1. Field of the Invention

The present invention relates to a device that can cut and grind a pill.

### 2. Description of the Prior Arts

Depending on age or body weight, different patients need to take different doses of medication. Some patients need to divide the medicine into the required dose according to the doctor's prescription before taking the medicine. In addition, some patients may have difficulty swallowing pills, so they need to grind the medicine into powder before taking it.

In view of this, a pill cutter and a pill grinder are provided. The pill cutter comprises a blade, so the user can divide the pill into the required doses according to the doctor's prescription. The pill grinder comprises a container, and the user can place the pill into the container and grind the pill up for ease of swallowing.

However, if the user needs to cut and grind the pill at the same time, the user needs to prepare one pill cutter and one pill grinder at the same time. For example, if it is necessary to grind half of the dose of the pill, the user first needs to use the pill cutter to divide the pill into two halves, and then use the pill grinder to grind one of the half-pills. Therefore, to meet the needs of cutting and grinding pills, the user needs to purchase and carry one pill cutter and one pill grinder at the same time, resulting in additional costs and difficulty in carrying.

In addition, the grinding head of the pill grinder is made of plastic. During grinding pills, the grinding head may be damaged easily or the medicine may adhere to the surface of the grinding head, which may lead to contamination of the ground pill or uneven thickness of the grinding particles.

To overcome the shortcomings, the present invention provides a pill-cutter-and-grinder to mitigate or obviate the aforementioned problems.

### SUMMARY OF THE INVENTION

The main objective of the present invention is to provide a pill-cutter-and-grinder that has the functions of both cutting and grinding pills.

The pill-cutter-and-grinder has a main body, a cutting lid, and a grinding container. The main body has a first end, a second end, a cutting seat, and a grinding head. The first end and the second end are two opposite ends of the main body. The cutting seat is mounted on the first end and has two baffles. The baffles are formed on the cutting seat and protrude from the second end. There is an angle formed between the baffles. The grinding head is mounted on the second end and protrudes from the first end. The cutting lid is mounted on an end of the cutting seat and has a blade mounted on an inner side of the cutting lid. When the cutting lid covers the cutting seat, the blade is located between the baffles, and a cutting edge of the blade faces toward the cutting seat. The grinding container is detachably combined with the second end of the main body. When the grinding container is located on the second end of the main body, the grinding head is located in the grinding container, and the grinding head is close to a bottom in the grinding container.

The advantage of the present invention is that the pill-cutter-and-grinder has the blade, the cutting seat, the grinding head, and the grinding container. By closing the cutting lid, the blade is driven to cut the pill placed on the cutting seat. In addition, through the combination of the grinding container and the main body, a space between the grinding head and the grinding container is reduced, thereby grinding the pill placed in the grinding container. Therefore, the user only needs to prepare one pill-cutter-and-grinder to cut and grind pills, saving the cost of purchasing tools and increasing the convenience of carrying.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a pill-cutter-and-grinder in accordance with the present invention;

FIG. 2 is a perspective view of the pill-cutter-and-grinder in FIG. 1, shown with the cutting lid opened;

FIG. 3 is an exploded view of the pill-cutter-and-grinder in FIG. 1;

FIG. 4 is another exploded view of the pill-cutter-and-grinder in FIG. 1; and

FIG. 5 is a sectional view of the pill-cutter-and-grinder in FIG. 1.

### DETAILED DESCRIPTION OF THE PREFERRED EMBODIMENTS

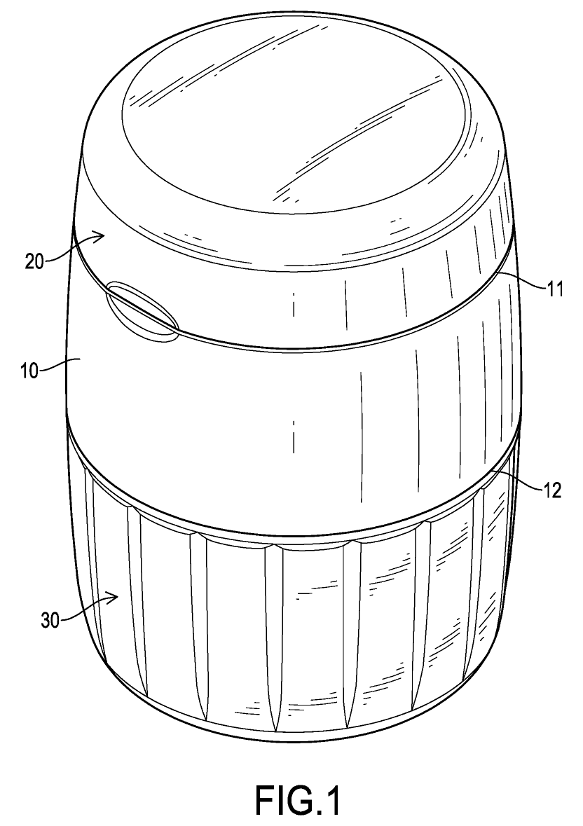

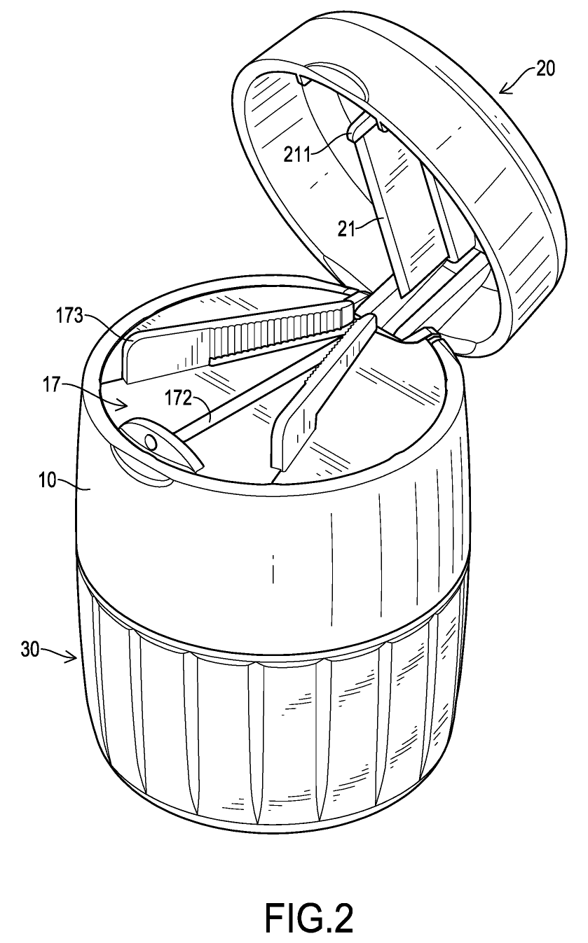

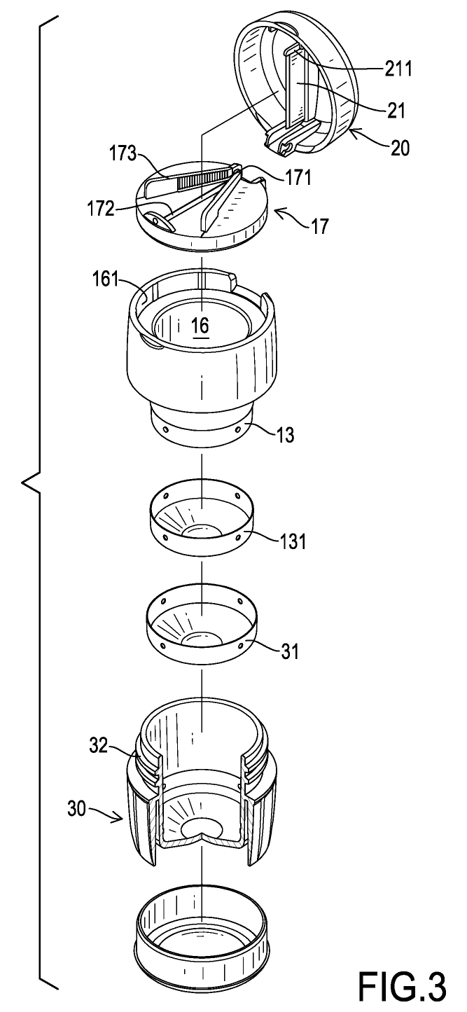

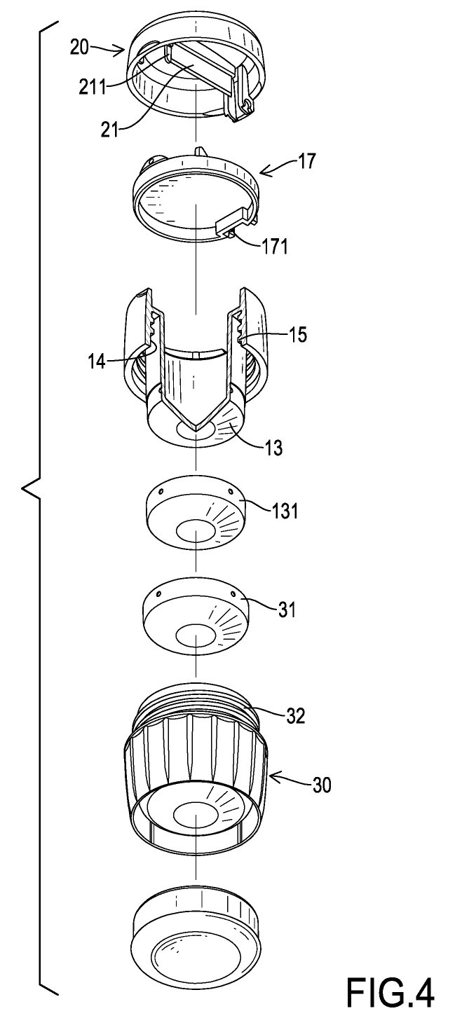

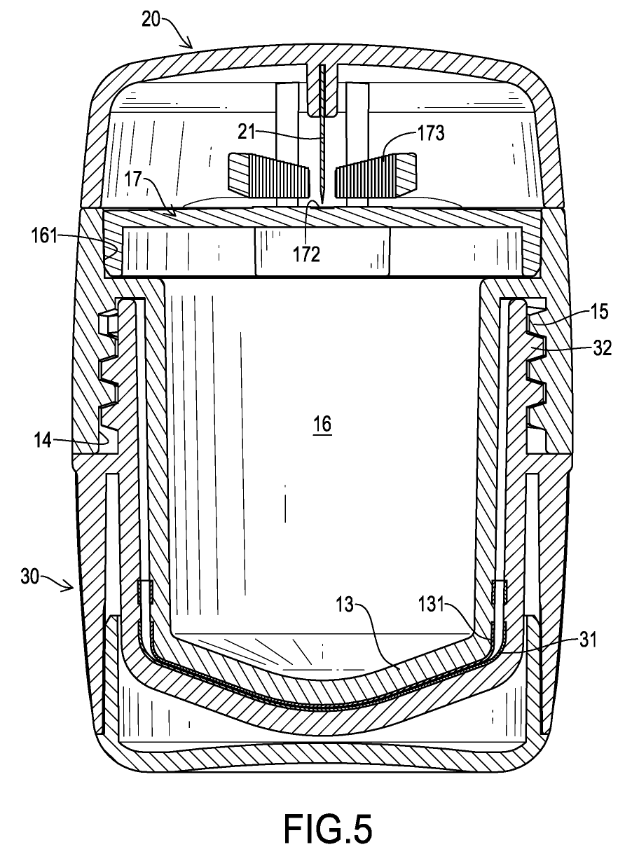

With reference to FIG. 1 to FIG. 5, a pill-cutter-and-grinder in accordance with the present invention is configured to cut or grind pills. The pill-cutter-and-grinder comprises a main body 10, a cutting lid 20, and a grinding container 30.

The main body 10 comprises a first end 11, a second end 12, a grinding head 13, a surrounding groove 14, an internal thread 15, a containing space 16, and a cutting seat 17. The first end 11 and the second end 12 are two opposite ends of the main body 10. The grinding head 13 is mounted on the second end 12. The grinding head 13 is arc-shaped and protrudes from the first end 11. The grinding head 13 comprises a first metal surface 131, and the first metal surface 131 is formed on a surface of the grinding head 13. In this embodiment, the first metal surface 131 is made of stainless steel, but not limited thereto. In this embodiment, the surrounding groove 14 is concaved around the main body 10 and is located between the first end 11 and the second end 12. The internal thread 15 is formed on a wall of the surrounding groove 14. The containing space 16 is located between the first end 11 and the second end 12 and comprises an opening 161. The opening 161 is formed on the first end 11 of the main body 10. The user can place or store pills in the containing space 16.

The cutting seat 17 is detachably mounted on the first end 11 and is engaged with the opening 161 of the containing space 16, such that the cutting seat 17 can block or connect the containing space 16 from or to outside. The cutting seat 17 comprises a shaft 171, a slot 172, and two baffles 173. The shaft 171 is formed on an edge of the cutting seat 17. The slot 172 is formed on a side of the cutting seat 17 away from the second end 12, and an end of the slot 172 faces toward the shaft 171. The baffles 173 are formed on the cutting seat 17 and protrude from the second end 12, and an angle is formed between the baffles 173. The baffles 173 are located on two sides of the slot 172 respectively and are symmetrical to each other with respect to the slot 172.

In this embodiment, ends of the baffles 173 close to the shaft 171 are close to each other. The ends of the baffles 173 away from the shaft 171 are away from each other. In other words, the angle between the baffles 173 is close to the shaft 171. In addition, each baffle 173 comprises a rough surface, and the rough surfaces of the two baffles 173 are opposite to each other. Therefore, when a pill is placed between the baffles 173, the pill is not likely to move during cutting. In another embodiment, the ends of the baffles 173 close to the shaft 171 can be away from each other, and the ends of the baffles 173 away from the shaft 171 can be close to each other. In other words, the angle between the baffles 173 is away from the shaft 171.

The cutting lid 20 is mounted on the main body 10. Precisely, the shaft 171 of the cutting seat 17 is mounted through the cutting lid 20, such that the cutting lid 20 can be rotated about the shaft 171 as the axis. Therefore, an edge of the cutting lid 20 can be attached to the edge of the cutting seat 17, and then the cutting lid 20 can block the cutting seat 17 from the outside. The cutting lid 20 can also be rotated until the edge of the cutting lid 20 is separated from the edge of the cutting seat 17. The cutting lid 20 comprises a blade 21 mounted on an inner side of the cutting lid 20. An end of the blade 21 faces toward a junction of the cutting lid 20 and the shaft 171. When the edge of the cutting lid 20 is attached to the edge of the cutting seat 17, the blade 21 is located between the baffles 173, and a cutting edge of the blade 21 is opposite to the slot 172 in position. In other words, when the blade 21 is located between the baffles 173, the baffles 173 are symmetrical to each other with respect to the blade 21. The blade 21 comprises a protecting unit 211 mounted on an end of the blade 21 away from the shaft 171. The protecting unit 211 extends from the cutting lid 20 to the cutting edge of the blade 21 and encloses the cutting edge. Therefore, when the user opens or closes the cutting lid 20, the protecting unit 211 can prevent the user's fingers from touching the cutting edge and getting injured.

The grinding container 30 comprises a second metal surface 31 and an external thread 32. The second metal surface 31 is formed on a bottom in the grinding container 30. In this embodiment, the second metal surface 31 is made of stainless steel, but not limited thereto. The grinding container 30 is detachably combined with the second end 12 of the main body 10. Precisely, in this embodiment, the external thread 32 of the grinding container 30 and the internal thread 15 of the main body 10 can be threaded with each other to combine the grinding container 30 and the main body 10. When the grinding container 30 and the main body 10 are combined, the grinding head 13 is located in the grinding container 30, and the first metal surface 131 of the grinding head 13 and the second metal surface 31 of the grinding container 30 contact each other. In another embodiment, the grinding container 30 may comprise an internal thread and the main body 10 may comprise an external thread.

When the pill-cutter-and-grinder is used to cut a pill, the user first opens the cutting lid 20 and places the pill between the baffles 173 of the cutting seat 17. At this time, the pill contacts the rough surfaces of the two baffles 173 at the same time. Then the user closes the cutting lid 20, and the force of closing the cutting lid 20 causes the blade 21 to cut the pill. Finally, the user opens the cutting lid 20 again to take out the pills after cutting. Since the distance between the blade 21 and the baffles 173 are the same, the pill is cut into two halves.

When the pill-cutter-and-grinder is used to grind a pill, the user first rotates the grinding container 30 to separate the external thread 32 of the grinding container 30 from the internal thread 15 of the main body 10 and places the pill into the grinding container 30. Then the user rotates the grinding container 30, such that the external thread 32 of the grinding container 30 and the internal thread 15 of the main body 10 are threaded with each other. During the threading process, the first metal surface 131 of the grinding head 13 and the second metal surface 31 of the grinding container 30 gradually approach each other, such that the pill located in the grinding container 30 is squeezed by the first metal surface 131 and the second metal surface 31. When the first metal surface 131 and the second metal surface 31 are in contact, the first metal surface 131 and the second metal surface 31 grind the pill into powder. Finally, the user separates the grinding container 30 from the main body 10 and pours out the powder in the grinding container 30.

The advantage of the present invention is that the pill-cutter-and-grinder comprises the blade 21, the cutting seat 17, the grinding head 13, and the grinding container 30. By closing the cutting lid 20, the blade 21 is driven to cut the pill placed on the cutting seat 17. In addition, through the combination of the grinding container 30 and the main body 10, a space between the grinding head 13 and the grinding container 30 is reduced, thereby grinding the pill placed in the grinding container 30. Therefore, the user only needs to prepare one pill-cutter-and-grinder to cut and grind pills, saving the cost of purchasing tools and increasing the convenience of carrying.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A pill-cutter-and-grinder configured to cut or grind a pill and comprising:
a main body comprising:
a first end;
a second end opposite the first end;
a cutting seat mounted on the first end and comprising:
two baffles formed on the cutting seat and protruding from the second end; an angle formed between the baffles;
a grinding head mounted on the second end; the grinding head protruding from the first end;
a cutting lid mounted on an end of the cutting seat and comprising:
a blade mounted on an inner side of the cutting lid; the blade located between the baffles when the cutting lid covers the cutting seat, and a cutting edge of the blade facing toward the cutting seat;
a grinding container detachably combined with the second end of the main body; the grinding head located in the grinding container when the grinding container is located on the second end of the main body, and the grinding head being close to a bottom in the grinding container and thereby grinding the pill therebetween.

2. The pill-cutter-and-grinder as claimed in claim 1, wherein:
the grinding head comprises a first metal surface;
the grinding container comprises a second metal surface on the bottom in the grinding container;
when the grinding head is located in the grinding container, the first metal surface is close to the second metal surface.

3. The pill-cutter-and-grinder as claimed in claim 2, wherein the first metal surface and the second metal surface are made of stainless steel.

4. The pill-cutter-and-grinder as claimed in claim 1, wherein the main body comprises:
a containing space comprising an opening, and the opening formed on the first end of the main body.

5. The pill-cutter-and-grinder as claimed in claim 3, wherein the main body comprises:
a containing space comprising an opening, and the opening formed on the first end of the main body.

6. The pill-cutter-and-grinder as claimed in claim 4, wherein the cutting seat is mounted in the opening of the containing space and is capable of blocking the containing space from an outside environment.

7. The pill-cutter-and-grinder as claimed in claim 5, wherein the cutting seat is mounted in the opening of the containing space and is capable of blocking the containing space from an outside environment.

8. The pill-cutter-and-grinder as claimed in claim 1, wherein the blade comprises a protecting unit extending from the cutting lid to the cutting edge of the blade.

9. The pill-cutter-and-grinder as claimed in claim 7, wherein the blade comprises a protecting unit extending from the cutting lid to the cutting edge of the blade.

10. The pill-cutter-and-grinder as claimed in claim 1, wherein the cutting seat comprises a slot corresponding to the cutting edge of the blade in location.

11. The pill-cutter-and-grinder as claimed in claim 9, wherein the cutting seat comprises a slot corresponding to the cutting edge of the blade in location.

12. The pill-cutter-and-grinder as claimed in claim 1, wherein the baffles are symmetrical to each other with respect to the blade.

13. The pill-cutter-and-grinder as claimed in claim 11, wherein the baffles are symmetrical to each other with respect to the blade.

14. The pill-cutter-and-grinder as claimed in claim 1, wherein the grinding head is arc-shaped.

15. The pill-cutter-and-grinder as claimed in claim 13, wherein the grinding head is arc-shaped.

16. The pill-cutter-and-grinder as claimed in claim 1, wherein:
the grinding container comprises an external thread;
the main body comprises an internal thread;
the grinding container and the main body are capable of being threaded with each other through the external thread and the internal thread and thereby grinding the pill during threading.

17. The pill-cutter-and-grinder as claimed in claim 15, wherein:
the grinding container comprises an external thread;
the main body comprises an internal thread;
the grinding container and the main body are capable of being threaded with each other through the external thread and the internal thread and thereby grinding the pill during threading.
